(19) United States
(12) Patent Application Publication
(10) Pub. No.: US 2026/0336052 A1
(43) Pub. Date: Oct. 29, 2026

(54) APPARATUS FOR REMOVING PARTICULATE ON DISPLAY GLASS EDGES

(71) Applicant: CORNING INCORPORATED, CORNING, NY (US)

(72) Inventors: JAMES WILLIAM BROWN, THE VILLAGES, FL (US); MING-HUANG HUANG, ITHACA, NY (US); GARY MICHAEL HUZINEC, HORSEHEADS, NY (US); LEI LI, CORNING, NY (US); WANDA JANINA WALCZAK, BIG FLATS, NY (US)

(21) Appl. No.: 19/121,483

(22) PCT Filed: Oct. 4, 2023
(86) PCT No.: PCT/US2023/034444

§ 371 Date: Apr. 16, 2025

Related U.S. Application Data
(60) Provisional application No. 63/416,995, filed on Oct. 18, 2022.

(51) Int. Cl. B24B 27/033; B08B 11/04

(52) U.S. Cl. CPC B24B 27/033; B08B 11/04

(57) ABSTRACT

A cleaning wheel for removing particles from a substrate and method of making the same is provided herein. The cleaning wheel comprises a composition including a first volume of a plurality of abrasive particles and a second volume of a polymer matrix, wherein the plurality of abrasive particles are suspended in the polymer matrix. The composition is formed with a porosity. The first volume is at least 20% and less than 35% of a total cleaning wheel volume. The second volume is at least 20% of the total cleaning wheel volume. The porosity is at least 35% of the total cleaning wheel volume.

### CROSS-REFERENCE TO RELATED APPLICATION

This application claims the benefit of priority under 35 U.S.C. § 119 of U.S. Provisional Application Ser. No. 63/416,995 filed on Oct. 18, 2022, the content of which is relied upon and incorporated herein by reference in its entirety.

### FIELD OF THE INVENTION

Embodiments of the present invention relate generally to cleaning apparatuses for glass substrates, and more particularly to the composition of cleaning wheels configured to effectively remove particulate from glass substrates.

### BACKGROUND OF THE INVENTION

Display glass panes may be finished by polishing and grinding the glass pane to produce the required geometry and flexural strength. However, glass particulates, formed through grinding and polishing the edges of the substrates (e.g., the glass panes) may migrate from the edge onto the major surface (e.g., the display surface) of the glass substrate. The glass particulate may cause deficiencies in the display quality, such as pixel drop-out.

### BRIEF SUMMARY OF THE INVENTION

Embodiments of the present disclosure are directed towards an edge cleaning wheel composition which removes and/or retains glass particulates from the formed edges of glass substrates to prevent negative effects on the glass substrate due to particle migration (e.g., due to pixel drop-out from fusion between the particles and the major surface of the substrate).

The inventive composition(s) may remove a higher percentage of glass particulates, while reducing the heat generated due to friction between the edge cleaning wheel and the glass substrate. This reduces the temperature of the glass particulates and prevents bonding between the glass particulates and the major surface of the substrate. The inventive composition(s) also provide for increased life of the cleaning wheel (e.g., increased number of uses). In this regard, some embodiments of the present invention utilize a composition formed of a plurality of abrasive particles, each being within a determined particle size range, suspended in a polymer matrix with porosity introduced. The composition is formed into a cleaning wheel that is used to rub against the substrate to remove the glass particles. Further, in some embodiments, the polymer matrix provides compliance within the edge cleaning wheel. In this regard, the polymer matrix may retain some of the glass particles on the edge cleaning wheel (thereby preventing them from migrating to the major (e.g., display) surface). Notably, porosity within the edge cleaning wheel provides structural compliance for the edge cleaning wheel to remove and retain the glass particulates from the glass substrate.

In an example embodiment, a cleaning wheel is provided. The cleaning wheel is formed of a composition comprising a first volume of a plurality of abrasive particles, and a second volume of a polymer matrix. The plurality of abrasive particles are suspended in the polymer matrix. The composition further comprises a porosity. The first volume of the abrasive particles is at least 20% and less than 35% of a total cleaning wheel volume. The second volume is at least 20% of the total cleaning wheel volume, and the porosity is at least 35% of the total cleaning wheel volume.

In some embodiments, the plurality of abrasive particles may be Silicon Carbide. In some embodiments, each of the plurality of abrasive particles comprise a particle size diameter between 20-50 microns. In some embodiments, the particle size diameter of each of the plurality of abrasive particles may be between 30-40 microns. In some embodiments, the first volume of abrasive particles may be between 20%-30% of the total cleaning wheel volume. In some embodiments, the first volume of abrasive particles may be between 20%-25% of the total cleaning wheel volume.

In some embodiments, the second volume of the polymer matrix may be between 20%-35% of the total cleaning wheel volume. In some embodiments, the second volume of the polymer matrix may be between 25%-30% of the total cleaning wheel volume. In some embodiments, the polymer matrix may be polyurethane.

In some embodiments, the porosity may be between 35%-55% of the total cleaning wheel volume. In some embodiments, the porosity may be between 45%-55% of the total cleaning wheel volume. In some embodiments, the cleaning wheel may comprise a hardness between 40-55 Shore D. In some embodiments, the cleaning wheel may be configured to remove at least 75% of substrate particles from a glass substrate.

In some embodiments, a coupling agent may be applied to the plurality of abrasive particles. In some embodiments, the coupling agent may be a metal coating.

In another example embodiment, a method of removing particles from a substrate is provided. The method comprises providing a cleaning wheel defining a cleaning wheel composition. The cleaning wheel composition comprising a first volume of a plurality of abrasive particles, and a second volume of a polymer matrix. The plurality of abrasive particles are suspended in the polymer matrix. The composition further comprises a porosity. The first volume of the abrasive particles is at least 20% and less than 35% of a total cleaning wheel volume. The second volume is at least 20% of the total cleaning wheel volume, and the porosity is at least 35% of the total cleaning wheel volume. The method further comprises applying a cooling liquid at an interface between the cleaning wheel and the substrate. The method further comprises rotating the cleaning wheel to remove substrate particles from the interface between the cleaning wheel and the substrate. The removed substrate particles are at least partially removed with the cooling liquid.

In some embodiments, the plurality of abrasive particles may be Silicon Carbide. In some embodiments, the polymer matrix may be polyurethane. In some embodiments, the composition may further comprise a coupling agent applied to the plurality of abrasive particles. In some embodiments, the substrate may be glass.

In yet another embodiment, a process of forming a cleaning wheel is provided. The process comprises combining a first volume of a plurality of abrasive particles in a second volume of a polymer matrix, and a third volume of pore inducer into a mixture. The process further comprises positioning the mixture into a mold and heating the mixture within the mold to form a cleaning wheel. The mold is heated to a temperature such that the pore inducer sublimes creating a porosity within the cleaning wheel.

In some embodiments, the first volume of the plurality of abrasive particles is at least 20% and less than 35% of a total cleaning wheel volume. In some embodiments, the second volume is at least 20% of a total cleaning wheel volume. In some embodiments, the porosity is at least 35% of a total cleaning wheel volume. In some embodiments, the process further comprises coating the plurality of abrasive particles with a coupling agent.

### BRIEF DESCRIPTION OF THE SEVERAL VIEWS OF THE DRAWING(S)

Having thus described the invention in general terms, reference will now be made to the accompanying drawings, which are not drawn to scale, and wherein:

FIG. 1A illustrates a cross-section view of an example cleaning wheel, in accordance with some embodiments discussed herein;

FIG. 1B illustrates a cross-sectional view of the example cleaning wheel and a glass substrate, in accordance with some embodiments discussed herein;

FIG. 1C illustrates a cross-sectional view of the example glass substrate being shaped and polished with the example cleaning wheel, in accordance with some embodiments discussed herein;

FIG. 2A illustrates a cross-sectional view of an example glass substrate with an imperfection, in accordance with some embodiments discussed herein;

FIG. 2B illustrates a top view of the example glass substrate, shown in FIG. 2A, in accordance with some embodiments discussed herein;

FIG. 3 illustrates an example composition of a cleaning wheel, in accordance with some embodiments discussed herein;

FIG. 4A illustrates an example edge cleaning wheel, in accordance with some embodiments discussed herein;

FIG. 4B illustrates the degradation of a groove due to thermal degradation, in accordance with some embodiments discussed herein;

FIG. 4C illustrates an example groove of a cleaning wheel without thermal degradation, in accordance with some embodiments discussed herein;

FIG. 4D illustrates an example groove of a cleaning wheel exhibiting thermal degradation, in accordance with some embodiments discussed herein;

FIGS. 5A-C illustrate the degradation of a groove of an example cleaning wheel over the lifespan of the example cleaning wheel, in accordance with some embodiments discussed herein;

FIGS. 6A-B illustrate the degradation of a groove of an example cleaning wheel over the lifespan of the example cleaning wheel, in accordance with some embodiments discussed herein;

FIG. 7A illustrates a cross-sectional view of grooves of a cleaning wheel, illustrating the structural densification of the grooves, in accordance with some embodiments discussed herein;

FIG. 7B illustrates a top view of the grooves of the example cleaning wheel, shown in FIG. 6A, in accordance with some embodiments discussed herein;

FIG. 8 illustrates a flow chart of an example method for using a cleaning wheel in accordance with some embodiments discussed herein;

FIG. 9 illustrates a flow chart of an example method for forming a cleaning wheel in accordance with some embodiments discussed herein; and

FIG. 10 is a graph illustrating the thermal effusivities of two example compositions, in accordance with some embodiments discussed herein.

### DETAILED DESCRIPTION

Some example embodiments will not be described more fully herein with reference to the accompanying drawings, in which some, but not all example embodiments are shown. Indeed, the examples described and pictured herein should not be construed as being limiting to the scope, applicability or configuration of the present disclosure. Rather, these example embodiments are provided so that this disclosure will satisfy applicable legal requirements. Like reference numerals refer to like elements throughout.

Glass substrates, which may be used to form laminates, typically have edge surfaces substantially orthogonal to the major surfaces. As glass substrates are cut from larger sheets, the edge surfaces may comprise micrometer-scale flaws such as sub-surface micro-cracks. If the glass substrate is subjected to stress, the cracks may further propagate causing breakage in the glass substrate. In addition, the edges form sharp corners that can easily chip and form surface-contaminating glass chips. To reduce breakage and/or to reduce chipping, the edge surfaces are typically finished using an edge finishing process to obtain a desired contour and smoothness. In addition, the edge finishing process may remove flaws from the edge surfaces and contour the corners.

The edge finishing process may utilize multiple wheels including grinding wheels, and edge cleaning wheels configured to both shape and polish the glass substrate.

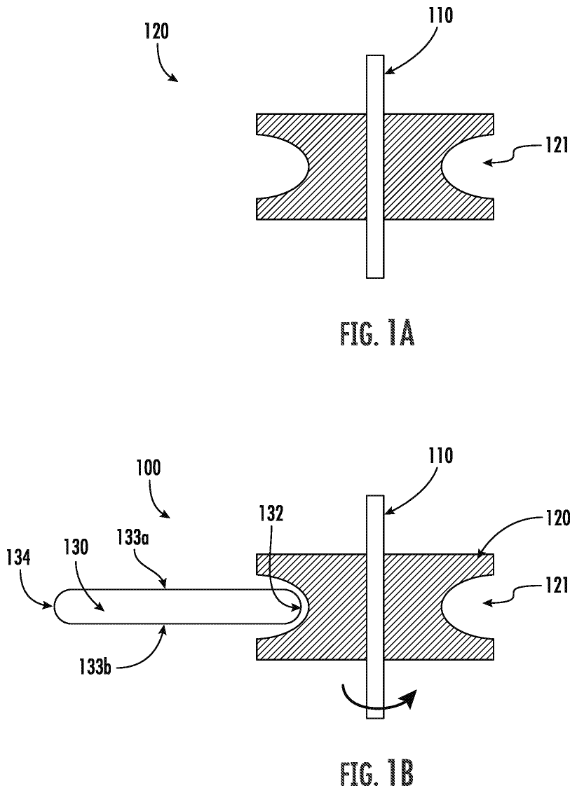

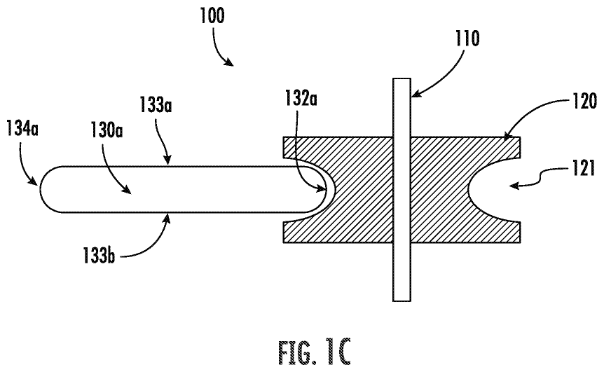

FIGS. 1A-C schematically illustrate a process for edge finishing a glass substrate using an edge cleaning wheel according to various example embodiments of the present disclosure. As used herein, edge cleaning may include one or both of grinding and polishing.

FIG. 1A illustrates a cross sectional view of an example edge cleaning wheel 120 comprised of a matrix structure described herein. The edge cleaning wheel 120 may have a preformed groove 121, which rotates about a spindle 110.

In some embodiments, a pre-finished glass substrate 130 may define a first major surface 133a and a second major surface 133b opposing the first major surface 133a. A first pre-finished edge 132 and a second pre-finished edge 134 may connect the first major surface 133a with the second major surface 133b.

In some embodiments, the pre-finished glass substrate 130 may undergo multiple edge finishing operations, including a shaping operation, a flaw reduction operation, and an edge cleaning operation. At the shaping operation, corners formed at each of the intersections of each of the first pre-finished edge 132 and the second pre-finished edge 134 with the first major surface 133a and the second major surface 133b may be contoured. In this regard, a grinding force may cause removal of the glass substrate at each of the corners, thereby rounding the corners.

At the flaw reduction operation, the number of flaws formed by the shaping wheel may be reduced. The flaw reduction operation may further provide a baseline polish to the first pre-finished edge 132 and the second pre-finished edge 134, thereby reducing the surface roughness. After each of these processes there may still be substrate particles on the first pre-finished surface 132 and the second pre-finished surface 134.

During edge cleaning one of the first pre-finished edge 132 or the second pre-finished edge 134 is positioned within the groove 121 of the edge cleaning wheel 120 to contact the edge cleaning wheel 120 as the edge cleaning wheel 120 rotates about the spindle 110.

During edge finishing, the first pre-finished edge 132 and the second pre-finished edge 134 are contoured by the edge cleaning wheel 120. In this regard, the groove 121 of the edge cleaning wheel 120 travels along the length of the pre-finished first edge 132. During edge cleaning, force may be applied by the edge cleaning wheel 120 to the pre-finished glass substrate 130. In this regard, the force may remove any substrate particles on the first pre-finished edge 132 and the second pre-finished edge 134, thereby polishing the first pre-finished edge 132 and the second pre-finished edge 134 into a first finished edge 132a and a second finished edge 134a, respectively (as shown in FIG. 1C). Thus, a finished glass substrate 130a may define the first finished edge 132a and the second finished edge 134a contoured in relation to the first major surface 133a and the second major surface 133b, as illustrated in FIG. 1C. Although illustrated with a single edge cleaning wheel 120, in some embodiments two edge cleaning wheels may be used to finish each of the first pre-finished edge 132 and the second pre-finished edge 134 simultaneously.

During edge cleaning the friction between the edge cleaning wheel 120 and the pre-finished glass substrate 130 causes removal of a portion of the stray glass material from the first pre-finished edge 132 and/or the second pre-finished edge 134. In one or more embodiments, the edge cleaning wheel 120 and the portions of the glass substrate subjected to the edge cleaning may be cooled by a fluid during edge finishing. In some embodiments, the cooling fluid may be a liquid such as water. In some embodiments, the particles removed from the pre-finished glass substrate 130 may flow away from a system 100 with the cooling fluid.

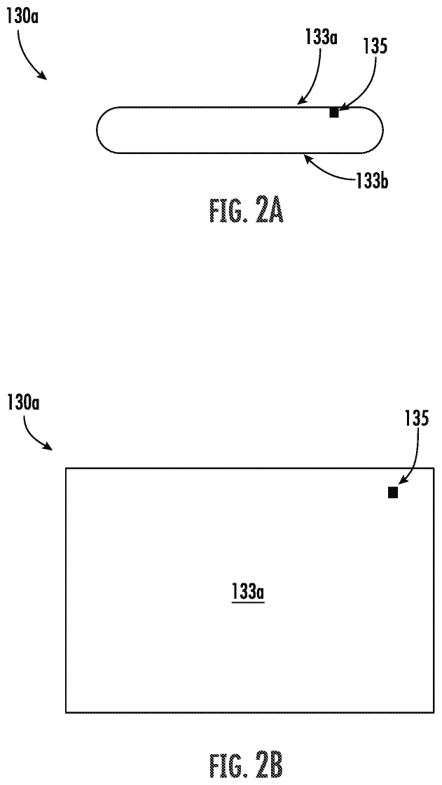

However, in some embodiments, some of the glass particles generated during the edge cleaning process may be expelled by the edge cleaning wheel and not removed by the cooling fluid. In this regard, as illustrated in FIGS. 2A-B, a glass particle 135 may migrate and adhere to the first major surface 133a or the second major surface 133b of the finished glass substrate 130a. This rogue glass particle may negatively affect display quality, such as by removing or blocking one or more pixels on the finished glass substrate 130a.

To explain, the rogue glass particle may migrate, such as through a micro crack or flaw extending from the first pre-finished edge 132, and become adhered to the first surface, after being displaced from the first pre-finished edge 132. Additionally, in some embodiments, the friction between the edge cleaning wheel 120 and the first pre-finished edge 132 or the second pre-finished edge 134 creates heat. The heat may cause the glass particles removed from the first pre-finished edge 132 or the second pre-finished edge 134 to heat up and/or retain the heat. In this regard, if one of the glass particles migrates onto either the first major surface 133a or the second major surface 133b as the glass particle cools, the glass particle may adhere to the respective surface, thereby knocking out one or more pixels.

As discussed with relative to various embodiments of the present invention, the composition of the edge cleaning wheel 120 may be modified to reduce the quantity of glass particles which are removed from the pre-finished glass substrate 130 and do not either remain on the edge cleaning wheel 120 or flow away from the edge cleaning wheel system 100 with the cooling fluid.

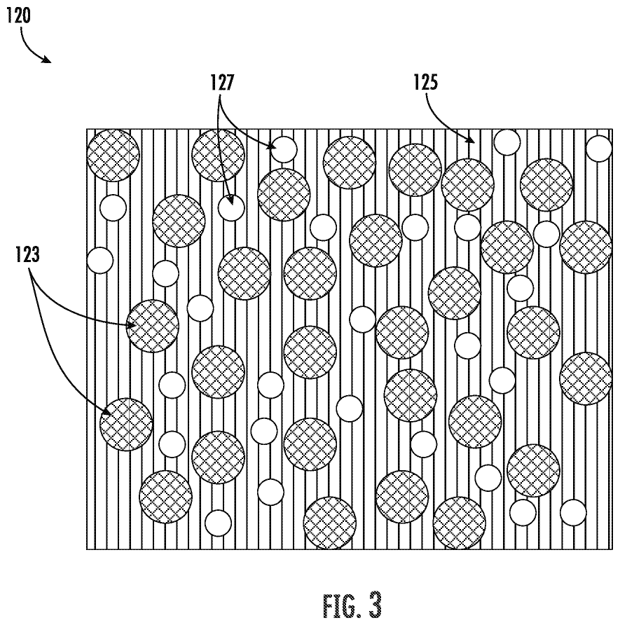

Example embodiments of the present invention provide edge cleaning wheels used in edge finishing of glass substrates that comprise a bonded matrix structure with abrasive particles within the matrix structure. Reference to abrasive particles “within” the matrix structure refers to the abrasive particles that are chemically bonded to and/or mechanically at least partially encapsulated within the matrix structure of the edge cleaning wheel. FIG. 3 illustrates the composition of the example edge cleaning wheel 120. The composition of the edge cleaning wheel 120 comprises a plurality of abrasive particles 123 suspended in a matrix 125, and defines a porosity 127.

The composition of the edge cleaning wheel 120 may comprise a first volume of the plurality of abrasive particles 123, a second volume of the matrix 125, and the porosity 127. In some embodiments, the composition of the edge cleaning wheel 120 defines a total cleaning wheel volume, wherein at least 20% and less than 35% of the total cleaning wheel volume comprises the plurality of abrasive particles, at least 20% of the total cleaning wheel volume comprises the matrix, and at least 35% of the total cleaning wheel volume is porous.

In some embodiments, the plurality of abrasive particles 123 may have a hardness that is greater than or equal to the hardness of the glass substrate. In some embodiments, the plurality of abrasive particles 123 may be configured to remove glass particles from the glass substrate, without causing the glass particles to re-adhere to the glass substrate. In some embodiments, the plurality of abrasive particles 123 may be silicon carbide (SiC), alumina (Al₂O₃), cubic boron nitride (CBN) and/or combinations thereof. In a preferred embodiment, the plurality of abrasive particles 123 may be SiC.

In some embodiments, the plurality of abrasive particles 123 may be specified in terms of particle size (and distribution thereof). In some embodiments, the plurality of abrasive particles 123 may define a particle diameter between 10-60 microns, between 20-50 microns, or between 30-40 microns. In some embodiments, the plurality of abrasive particles 123 may be less than 200 mesh, less than 300 mesh, less than 400 mesh, less than 500 mesh or even less than 600 mesh. In some embodiments, the plurality of abrasive particles 123 may be between 400-600 mesh.

In some embodiments, the plurality of abrasive particles 123 may contribute to and/or control the life span of the edge cleaning wheel 120. In this regard, a larger quantity of abrasive particles may increase the life of the edge cleaning wheel 120 as the workload per individual particle is reduced. However, a higher first volume (e.g., the volume of the plurality of abrasive particles 123) may increase the heat generated by the edge cleaning wheel 120 during cleaning. Thus, a balance in the first volume between sufficient life of the edge cleaning wheel 120, and heat generated during edge cleaning may be required.

In some embodiments, the first volume may be at least 20% of the total edge cleaning wheel volume, at least 25% of the edge cleaning wheel volume, or even at least 30% of the edge cleaning wheel volume. In some embodiments, the first volume may be between 20%-30% of the total edge cleaning wheel volume, and more preferably between 20%-25% of the total edge cleaning wheel volume. In some embodiments, the first volume may be increased by decreasing the mesh size of the plurality of abrasive particles 123.

In some embodiments, the matrix 125 may be configured to bind the plurality of abrasive particles 123 to one another. In some embodiments, the matrix 125 may provide inherent material compliance to the edge cleaning wheel 120. In some embodiments, the matrix 125 may be configured to retain the glass particles removed from the glass substrate, during edge cleaning.

In some embodiments, the matrix 125 may be a polymer matrix. In some embodiments, the matrix 125 may comprise polyurethane, or other polymers which may provide similar compliance properties to polyurethane.

In some embodiments, the matrix 125 may be selected for thermal stability characteristics. In this regard, the matrix 125 may retain structure when exposed to high heat (e.g., due to friction between the edge cleaning wheel and the glass substate). In some embodiments, the matrix 125 may display a high thermal effusivity. Thermal effusivity is a heat transport property related to the efficiency of a substrate (e.g., the matrix 125) to transfer heat to the surroundings (e.g., air). Thus, the matrix 125 may be selected to have an acceptable thermal effusivity over a range of temperatures, or specifically for the operating temperature.

In some embodiments, the second volume (e.g., the volume of the matrix 125) may be at least 20% of the total edge cleaning wheel 120, at least 25% of the edge cleaning wheel volume, or even at least 30% of the edge cleaning wheel volume. In some embodiments, the first volume may be between 20%-35% of the total edge cleaning wheel volume, and more preferably between 25%-30% of the total edge cleaning wheel volume.

In some embodiments, the compliance of the matrix 125 may be modified to possess a range of durometers. In this regard, the composition of the matrix 125 may provide bonding properties between the glass particles and the edge cleaning wheel 120.

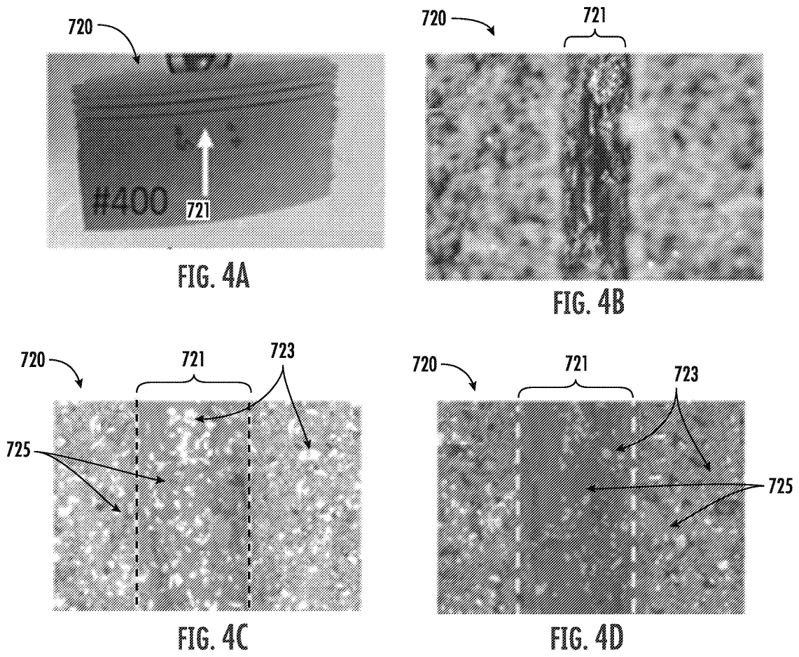

In some embodiments, the porosity 127 may contribute to structural compliance of the edge cleaning wheel 120. In some embodiments, the porosity 127 of the edge cleaning wheel 120 may contribute to heat dissipation during edge cleaning. In this regard, the heat generated from the friction between the edge cleaning wheel 120 and the first pre-finished edge (e.g., 132 FIG. 1), may be dissipated through the porosity of the edge cleaning wheel 120—thereby reducing the temperature of the glass particles removed from the first pre-finished edge. To explain, in the edge cleaning process when a cooling liquid may be applied at the interface between the first pre-finished edge 132 and the edge cleaning wheel 120, some of the cooling liquid may flow through the porosity 127 of the edge cleaning wheel 120, thus, dissipating heat from within the edge cleaning wheel 120, as illustrated with reference to FIGS. 4A-D.

In some embodiments, the combination of the structural compliance provided by the porosity 127 and the material compliance provided by the matrix 125 creates a localized product compliance within the edge cleaning wheel 120 at the contact points between the edge cleaning wheel and the glass substrate (see e.g., FIG. 1C). Further, the combination of the structural and material compliance may define the hardness of the edge cleaning wheel 120. In some embodiments, the edge cleaning wheel 120 may define a hardness defined on the Shore D scale between 40-55.

In some embodiments, porosity 127 of the edge cleaning wheel 120 may be at least 35% of the total edge cleaning wheel volume, at least 40% of the total edge cleaning wheel volume, at least 45% of the total edge cleaning wheel volume, or at least 50% of the total edge cleaning wheel volume. In some embodiments, the porosity 127 may be between 35%-55% of the total edge cleaning wheel volume, or more preferably between 45%-55% of the total edge cleaning wheel volume.

In some embodiments, the composition of the edge cleaning wheel 120 may further comprise a coupling agent. In some embodiments, the coupling agent may be applied to the plurality of abrasive particles 123 prior to mixing with the matrix 125. In this regard, the coupling agent may be configured to improve the bond between the matrix 125 and the plurality of abrasive particles 123. In some embodiments, the coupling agent may be a silane, or similar compound. In this regard, as the surface of the edge cleaning wheel 120 is degraded, the plurality of abrasive particles 123 remain adhered to the matrix 125 and thus, the plurality of abrasive particles do not bond to the glass substrate. In some embodiments, the coupling agent may contribute to a removal mechanism favorable to the reduction of adhered glass particles with minimal generation of new glass debris from the glass substrate. In some embodiments, the coupling agent may be a metal coating. In this regard, the metal coating may create a rough surface on the plurality of abrasive particles 123, such that the matrix 125 may develop a mechanical bond therewith.

In some embodiments, the porosity 127 within the composition of the edge cleaning wheel is created with a pore inducer. The pore inducer may be configured to foam, or sublime, during heating and/or compression thereby generating a porosity within the formed edge cleaning wheel 120.

### EXAMPLES

FIGS. 4A-7B illustrate images of edge cleaning wheels with different compositions, as the length of glass substrate exposed to the edge cleaning wheel increases. at different times in the edge cleaning wheel life span. Table 1 illustrates four example edge cleaning wheel compositions discussed herein. Notably, the compositions are defined in ranges of volume percentage of a total cleaning wheel volume. Each composition tested for the below description falls within the volume ranges for each of abrasive particles (Volume 1%), matrix (Volume 2%), and porosity (Porosity).

TABLE 1

| | Volume | Volume | | Particle | | Bond |
|---|---|---|---|---|---|---|
| Composition | 1% | 2% | Porosity | Removal | Wheel Life | Type |
| A | 20-25 | 25-30 | 45-55 | Superior (100) | Good (100) | Compliant |
| B | 25-30 | 20-35 | 35-55 | Good (75) | Great (150) | Compliant |
| C | 35-45 | 40-45 | 10-25 | Insufficient | Superior | Non- |
| | | | | (50) | (150) | compliant |
| D | 40-50 | 20-25 | 25-40 | Ineffective (0) | Ineffective | Non- |
| | | | | | (0) | compliant |

The compositions within Table 1 were tested for particle removal along a glass substrate to compare the life of the edge cleaning wheel and the amount of glass particles removed by the edge cleaning wheel. In this regard, the life of the edge cleaning wheel was determined based on the depth of the groove (e.g., 121 FIG. 1B) created by contacting the edge cleaning wheel to a glass substrate. Notably, a relative rating (e.g., superior, great, good, insufficient, and ineffective) was assigned based on performance during testing and a corresponding relative number value was determined accordingly. Further, there is an indication for each composition of the resultant bond-type as being compliant or non-compliant for retaining removed particles.

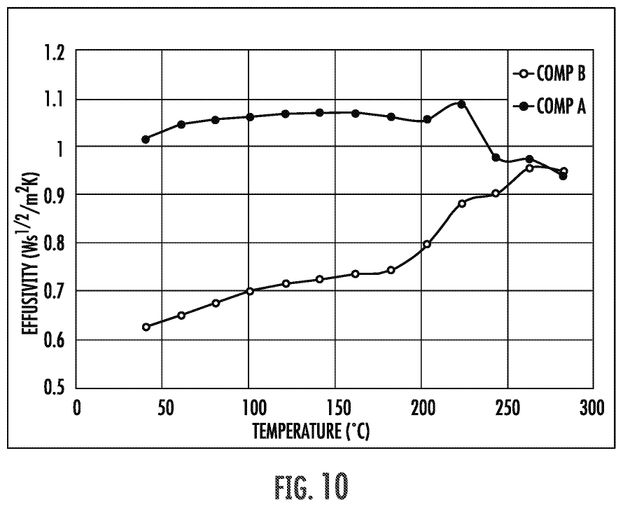

Each of the Compositions A-D utilized SiC as the plurality of abrasive particles. Composition A utilized polyurethane for the matrix, while Composition B utilized a different matrix. Compositions A and B utilized a coupling agent, while Compositions C and D did not include a coupling agent. Composition A displayed a steady effusivity across a range of operating temperatures, while the effusivity of Composition B increased as the operating temperature increased, as illustrated in FIG. 10.

It was found that Compositions A and B had relative superior overall performance. Composition A removed the greatest amount of glass particles from the glass substrate while exhibiting a good wheel life span. Composition B removed a sufficient amount of glass particles and exhibited a great wheel life span. Composition C did not remove an adequate amount of the glass particles from the glass substrate. Thus, although Composition C exhibited the greatest life span, the performance was inadequate. Composition D generated an excessive amount of heat when tested, and thus, did not yield reputable results (e.g., the excessive heat would lead to actually increasing the number of adhered removed particles to the display).

Each of Composition A and Composition B included a coupling agent to increase the compliance of the edge cleaning wheel. In this regard, without being bound by theory it is believed that the use of a coupling agent in the composition of the edge cleaning wheel increases the quantity of glass particles removed from the glass substrate during the cleaning process. The performance of Composition A and B are illustrated in FIGS. 4A-7B as discussed below.

FIGS. 4A-D illustrate thermal degradation of an edge cleaning wheel 720. FIG. 4A illustrates the edge cleaning wheel 720 comprising a groove 721, to receive pre-finished edges of glass substrates (e.g., first pre-finished edge 132 of FIG. 1). FIG. 4B illustrates the thermal degradation of the edge cleaning wheel 720 within the groove 121. As illustrated, the composition of the edge cleaning wheel 720 within the groove 121 had degraded in comparison to the portion of the edge cleaning wheel 720 external to the groove 121. To further explain, FIG. 4C illustrates the edge cleaning wheel 720 and groove 721 without thermal degradation, while FIG. 4D illustrates the edge cleaning wheel 720 and groove 721 with thermal degradation. In this regard, a plurality of abrasive particles 723 are evenly distributed throughout a matrix 725 within the groove 721 and external to the groove 721, with proper thermal control, illustrated in FIG. 4C. In contrast, the edge cleaning wheel 720 without thermal control, depicted in FIG. 4D, degrades within the groove 721, illustrated by the change in the distribution of the plurality of abrasive particles 723 throughout the matrix 725 within the groove 721, and outside of the groove 721. Thus, without thermal control, the edge cleaning wheel 720 may be exposed to high heat during the finishing process thereby causing loss of the plurality of abrasive particles 723, and shortening the life of the edge cleaning wheel 720.

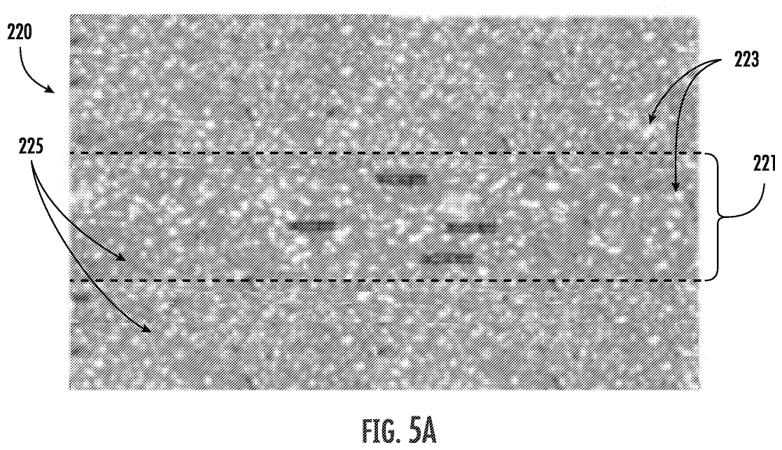

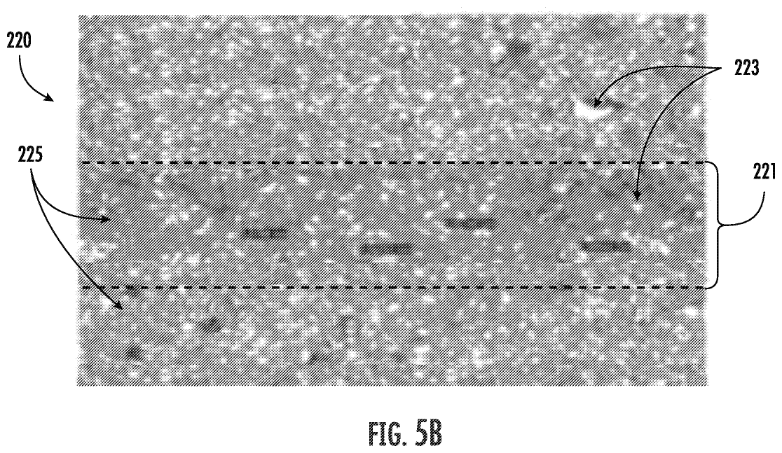

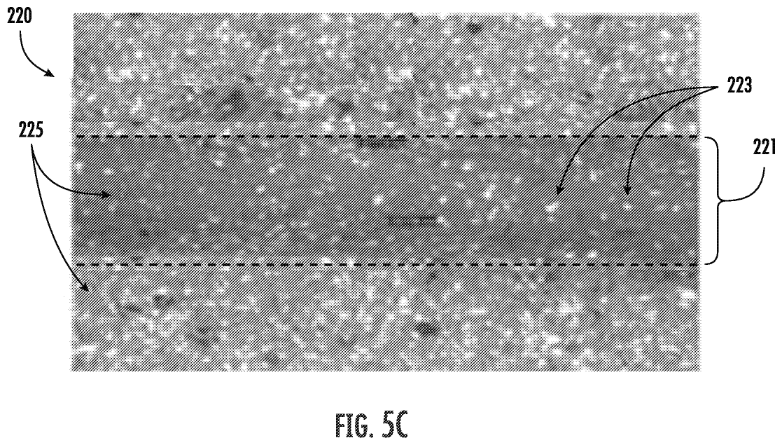

FIGS. 5A-C show scanning electron microscope (SEM) images of an example edge cleaning wheel 220 with Composition B comprising SiC 233 (abrasive particles) and a matrix 225, but without a coupling agent. The length of glass substrate edge engaged with a groove 221 of the edge cleaning wheel 220 increased from 50 meters (FIG. 5A) to 200 meters (FIG. 5C). FIG. 5A illustrates the edge cleaning wheel 220 defining the groove 221 with a depth of 50 microns. As the length of glass substrate edge processed increased, the depth of the groove increased, and there was a reduction of the plurality of abrasive particles 233 within the groove 221. For example, the groove 221 depicted in FIG. 5B is 115 microns deep, and the groove 221 depicted in FIG. 5C is 478 microns deep. Thus, as the length of glass substrate processed increases, the deeper the groove 221 of the edge cleaning wheel 220 becomes and there is less retention of the plurality of abrasive particles 223.

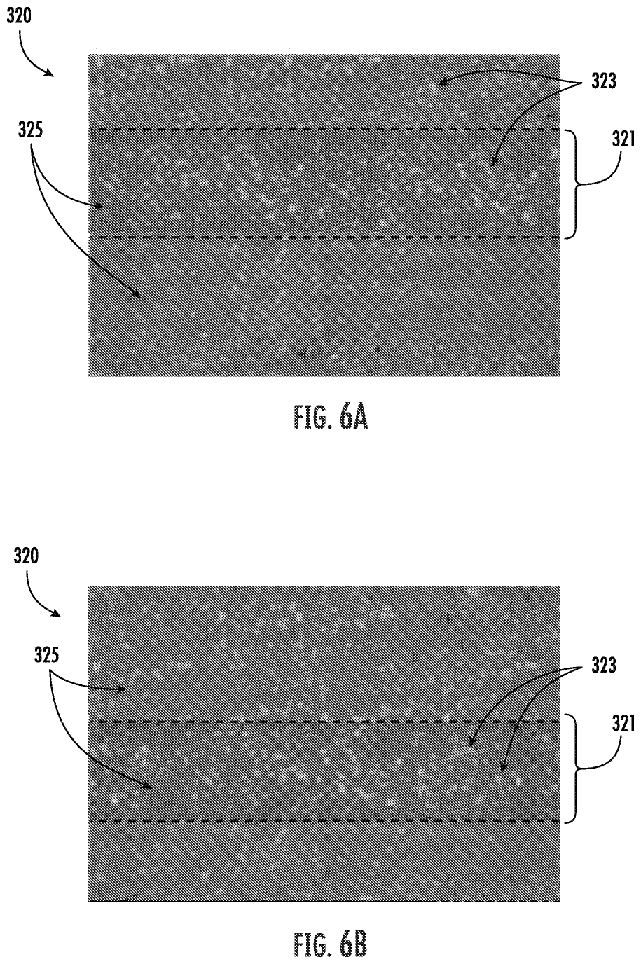

FIGS. 6A-B show SEM images of an example edge cleaning wheel 320 with Composition A comprising SiC 323 and a polyurethane matrix 325, with a coupling agent, as the length of the glass substrate engage with a groove 321 of the edge cleaning wheel 320 increased from 50 meters to 200 meters. FIG. 6A illustrates the surface of the edge cleaning wheel 320 after 50 meters of contact with a glass substrate, while FIG. 5B illustrates the surface of the edge cleaning wheel 320 after 200 meters of contact with a glass substrate.

In comparison of Composition A (FIG. 6B) and Composition B (without the coupling agent) (FIG. 5C) after 200 meters of cleaning, it is seen that the edge cleaning wheel 320 comprising Composition A retains more of the SiC within the cleaning wheel, than the edge cleaning wheel 220 comprising Composition B. In this regard, it may be determined that utilizing a coupling agent may contribute to retention of the plurality of abrasive particles within the groove of the edge cleaning wheel.

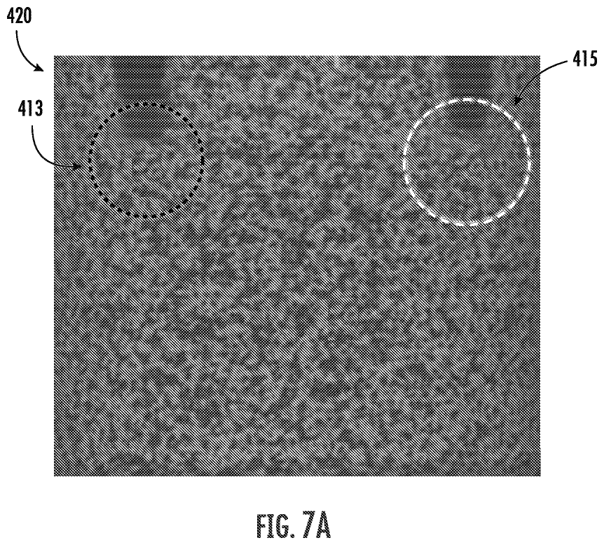

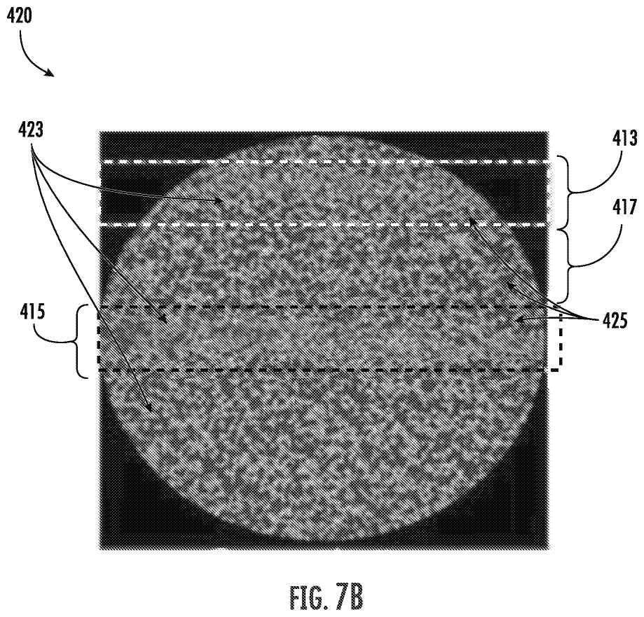

FIGS. 7A-B illustrate an XRT image of the combined effect of matrix compliance, porosity, and the contact pressure between an edge cleaning wheel 420 and a glass substrate. As depicted, the edge cleaning wheel 420 comprises two distinct grooves, a first groove 413 and a second groove 415, separated by a non-grooved surface 417 there between. Each of the first groove 413 and the second groove 415 depict structural densification at the bottom of the groove. In this regard, as the life of the edge cleaning wheel 420 increases there may be an increase in the abrasive particle grain density (e.g., SiC particles) within the groove of the edge cleaning wheel 420. The structural densification within the first groove 413 and the second groove 415, is seen in FIG. 7B. As depicted, edge cleaning wheel 420 comprises a plurality of abrasive particles 423, and a matrix 425. In each of the first groove 413 and the second groove 415 there is a higher density of the plurality of abrasive particles 423, and a lower density of the matrix 425 when compared to the non-grooved surface 417. Thus, as the edge cleaning wheel is exposed to a larger length of glass substrate the concentration of the plurality of abrasive particles decreases.

### Example Flowchart(s)

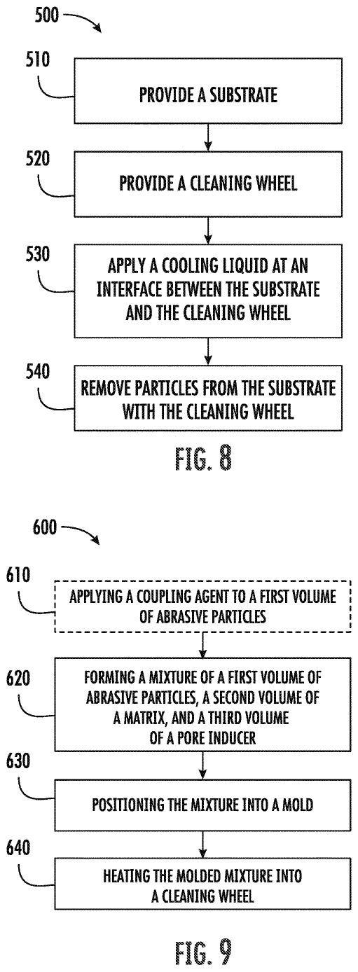

FIG. 8 is a flowchart illustrating an example method 500 for removing particles from a glass substrate in accordance with some embodiments discussed herein. At operation 510, a substrate is provided, such as a glass substrate. At operation 520, an edge cleaning wheel is provided. In some embodiments, the edge cleaning wheel may be formed utilizing one of the above described compositions. At operation 530, a cooling liquid may be applied at an interface between the substrate and the cleaning wheel during operation. In some embodiments, the cooling liquid may be water, or another liquid, such as configured to dissipate heat and/or remove any particles removed from either the cleaning wheel or the substrate. At operation 540, particles may be removed from the substrate with the cleaning wheel. In some embodiments, the particles may be removed within a stream of the cooling liquid or may be retained within the porosity of the cleaning wheel.

FIG. 9 is a flowchart illustrating an example method 600 for forming an edge cleaning wheel in accordance with some embodiments discussed herein. Optionally, at operation 610, a coupling agent may be applied to a first volume of abrasive particles. At operation 620, a mixture may be formed comprising the first volume of abrasive particles, a second volume of a matrix, and a third volume of a pore inducer. At operation 630, the mixture may be positioned into a mold. At operation 640, the molded mixture may be heated. In some embodiments, the pore inducer may subline during heating. In some embodiments, the molded mixture may be optionally heated and un-axially compressed during formation. After formation, the formed cleaning wheel may be removed from the mold.

Notably, the above operations for FIGS. 8-9, while described in a certain order, may be performed in a different order and/or some of the operations may be performed simultaneously.

### CONCLUSION

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

1. A cleaning wheel, wherein the cleaning wheel is formed of a composition comprising:
a first volume of a plurality of abrasive particles;
a second volume of a polymer matrix, wherein the plurality of abrasive particles are suspended in the polymer matrix; and
wherein the composition defines a porosity,
wherein the first volume is at least 20% and less than 35% of a total cleaning wheel volume, the second volume is at least 20% of the total cleaning wheel volume, and the porosity is at least 35% of the total cleaning wheel volume.

2. The cleaning wheel of claim 1, wherein the plurality of abrasive particles are silicon carbide.

3. The cleaning wheel of claim 1, wherein each abrasive particle of the plurality of abrasive particles comprises a particle diameter between 20-50 microns.

4. The cleaning wheel of claim 3, wherein the particle diameter of each particle of the plurality of abrasive particles is 30-40 microns.

5. The cleaning wheel of claim 1, wherein the first volume of the plurality of abrasive particles is between 20%-30% of the total cleaning wheel volume.

6. The cleaning wheel of claim 5, wherein the first volume of the plurality of abrasive particles is between 20%-25% of the total cleaning wheel volume.

7. The cleaning wheel of claim 1, wherein the second volume of the polymer matrix is between 20%-35% of the total cleaning wheel volume.

8. The cleaning wheel of claim 1, wherein the second volume of the polymer matrix is between 25%-30% of the total cleaning wheel volume.

9. The cleaning wheel of claim 1, wherein the polymer matrix comprises polyurethane.

10. The cleaning wheel of claim 1, wherein the porosity is between 35%-55% of the total cleaning wheel volume.

11. The cleaning wheel of claim 1, wherein the porosity is between 45%-55% of the total cleaning wheel volume.

12. The cleaning wheel of claim 1, wherein the cleaning wheel comprises a hardness between 40-55 Shore D.

13. The cleaning wheel of claim 1, wherein the cleaning wheel is configured to remove at least 75% of particles from a glass substrate.

14. The cleaning wheel of claim 1, further comprising a coupling agent applied to the plurality of abrasive particles.

15. The cleaning wheel of claim 14, wherein the coupling agent comprises a metal coating.

16.-25. (canceled)
